(19) United States
(12) Patent Application Publication
(10) Pub. No.: US 2025/0303560 A1
(43) Pub. Date: Oct. 2, 2025

(54) ROBOT MOTION LEARNING DEVICE, MOTION LEARNING SYSTEM, AND MOTION LEARNING METHOD

(71) Applicant: HITACHI, LTD., Tokyo (JP)

(72) Inventor: Kenjiro YAMAMOTO, Tokyo (JP)

(21) Appl. No.: 18/991,993

(22) Filed: Dec. 23, 2024

(30) Foreign Application Priority Data
Mar. 29, 2024 (JP) 2024-056408

(51) Int. Cl. B25J 9/16

(52) U.S. Cl. CPC B25J 9/163

(57) ABSTRACT

A robot motion learning device includes: a plurality of first learning models that receive motion information at a certain time and convert the motion information into features, for robots; a shared learning model that converts the features output by the first learning models into predicted features at a next time that are common to the plurality of types of robots; a plurality of second learning models that convert the predicted features at the next time into predicted motion information, for the plurality of types of robots; and a management unit that uses teaching data related to motion of the robots to train either the first learning model and the second learning model related to the robot or the shared learning model.

### CROSS-REFERENCE TO RELATED APPLICATION

This application is based upon and claims priority from the Japanese Patent Application No. 2024-056408, filed on Mar. 29, 2024, the entire contents of which are incorporated herein by reference.

### BACKGROUND OF THE INVENTION

### Technical Field

The present invention relates to a robot motion learning device, motion learning system and motion learning method, whereby it is possible to share and transfer learning information and learning models even among a plurality of types of robots, especially those with different mechanisms, structures, characteristics, or the like, with respect to a robot system that autonomously generates robot motion control sequences by learning robot motion data.

### Background Art

Work at manufacturing and construction sites, and maintenance and servicing work of infrastructure facilities such as railroads, plants, electricity, and buildings, require advanced skills and are dangerous and heavy labor, making it difficult to secure workers, and automation using robots is expected. However, conventional control methods, in which all robot motions are written as a program, cannot handle situations that are not written. For this reason, the scope of use of robots is limited to applications where the environment is maintained to be constant and the same tasks are repeated, making it difficult to apply the robots to tasks that need to respond to environmental changes, such as those described above.

Therefore, artificial intelligence (AI) using training, including neural computing, has been attracting attention. For example, by utilizing deep learning, a certain degree of environmental change can be handled with the generalization capability of deep learning without the need to write a program. In addition, even in the face of major environmental changes, the robot will be able to respond to new situations by learning teaching data for operating the robot in that environment.

However, in order to bring out the advantages of such learning method, it is necessary to properly prepare teaching data for use in learning and to properly provide the parameters of the motion learning model that acquires motion information, for learning. If the teaching data and parameters are insufficient, good robust and generalizable motion cannot be acquired. As the teaching data, motion data under a plurality of situations is required to respond to environmental changes, and the teaching data is prepared by combining data using simulations and data from actual operation of the robot. Reinforcement learning, a method of deep learning, requires tens of thousands to hundreds of millions of pieces of teaching data. As described above, the learning method has the problem that obtaining of teaching data is a heavy burden. Therefore, if a motion learning model that has acquired robust and generalizable high-quality motions can be used for other robots, the burden of acquiring high-quality motions, such as the burden of acquiring teaching data, can be reduced.

Patent Literature 1 discloses a method for obtaining a general-purpose learned model by integrating a plurality of individual learned models obtained through training based on individual motion data acquired by a group of motion devices having the same configuration.

### CITATION LIST

### Patent Literature

Patent Literature 1: Japanese Unexamined Patent Application Publication No. 2023-89023

### SUMMARY OF INVENTION

### Technical Problem

By using the training method described in Patent Literature 1, it is possible to autonomously generate robust motion even in the face of environmental changes. However, in order to acquire high-quality motion, the training load, such as obtaining the appropriate quality and quantity of teaching data, parameter tuning, and computational costs, is an issue.

If a plurality of robots with the same structure are used, the training load can be reduced by collecting and integrating teaching data for different motions using the plurality of robots in the manner described in Patent Literature 1. Robots with the same structure refer to robots with a range of structures and characteristics that can be considered identical.

In addition, if a plurality of robots have the same structure but different characteristics, such as the correction amount of a target stop position, and the differences in characteristics between the robots have a clear numerically corresponding correction amount, the training load can be reduced by adding the correction amount to the method described in Patent Literature 1 and transferring the learning results of a trained robot to an untrained robot. However, in the case of robots of the same structure but with unknown differences in characteristics or robots with different mechanisms and structures, it is not possible to share or transfer learned learning information or learning models. It is therefore necessary to obtain appropriate teaching data for each robot and perform parameter tuning. In other words, the training load to acquire high-quality motion is problematic. As a result, the invention of Patent Literature 1 has the problem that high-quality motion cannot be acquired. As mentioned above, this problem is particularly pronounced in the case of robots that perform work at manufacturing and construction sites, and maintenance and servicing work of infrastructure facilities such as railroads, plants, electricity, and buildings, where various types of robots exist depending on the situation.

Accordingly, the present invention addresses the problem of reducing the training load on learning models for controlling a plurality of types of robots.

### Solution to Problem

In order to address the above-mentioned problem, a robot motion learning device according to the present invention includes: a plurality of first learning models that receive motion information at a certain time and convert the motion information into motion features, and also receive external information at the time and convert the external information into external features, for a plurality of types of robots; a shared learning model that converts the motion features and external features output by the first learning models into predicted motion features at a next time that are common to the plurality of types of robots; a plurality of second learning models that convert the predicted motion features at the next time into predicted motion information, for the plurality of types of robots; and a management unit that uses teaching data related to motion of each of the robots to train either the first learning model and the second learning model related to the robot or the shared learning model.

A robot motion learning system according to the present invention includes the robot motion learning device and a plurality of types of robots.

A robot motion learning method according to the present invention is a robot motion learning method for learning motions of a plurality of types of robots and includes the steps of: causing a first learning model corresponding to a robot to learn processing for converting motion information and external information of the robot at a certain time into common motion features using teaching data related to the motion of the robot; causing a shared learning model to learn a time-series relationship of the common motion features related to motions common to the plurality of types of robots using the teaching data related to the motions of the plurality of types of robots; and causing a second learning model corresponding to the robot to learn processing for converting predicted values at a next time of the common motion features output by the shared learning model into predicted motion information of the robot at the next time using the teaching data related to the motion of the robot.

Other means will be described in Description of Embodiment.

### Advantageous Effects of Invention

According to the present invention, it is possible to reduce the training load on learning models for controlling a plurality of types of robots.

### BRIEF DESCRIPTION OF DRAWINGS

FIG. 1 illustrates a configuration example of a motion learning device for robots according to a first embodiment.

FIG. 2 is an example of a configuration of a motion learning system.

FIG. 3 is an example of a hardware configuration of the motion learning device.

FIG. 4 is an example of the hardware configuration of the motion learning device.

FIG. 5 illustrates one example of a detailed configuration of the motion learning device.

FIG. 6 illustrates one example of the detailed configuration of the motion learning device.

FIG. 7 illustrates one example of the detailed configuration of the motion learning device.

FIG. 8 is an overall sequence relating to learning of the motion learning device.

FIG. 9A is initial learning processing of the motion learning device.

FIG. 9B is initial learning processing of the motion learning device.

FIG. 9C is initial learning processing of the motion learning device.

FIG. 9D is initial learning processing of the motion learning device.

FIG. 10A is unlearned motion learning processing of the motion learning device.

FIG. 10B is unlearned motion learning processing of the motion learning device.

FIG. 10C is unlearned motion learning processing of the motion learning device.

FIG. 11A is new robot addition processing of the motion learning device.

FIG. 11B is new robot addition processing of the motion learning device.

FIG. 11C is new robot addition processing of the motion learning device.

FIG. 12A is individual robot learning processing of the motion learning device.

FIG. 12B is individual robot learning processing of the motion learning device.

FIG. 12C is individual robot learning processing of the motion learning device.

FIG. 12D is individual robot learning processing of the motion learning device.

### DESCRIPTION OF EMBODIMENTS

Hereinafter, an embodiment of the present invention will be described in detail with reference to the accompanying drawings. Note that the embodiment described below is merely an example for implementing the present disclosure, and should be appropriately modified or changed depending on the configuration of the device to which the present disclosure is applied and various conditions, and the present disclosure is not limited to the embodiment described below.

### System Configuration

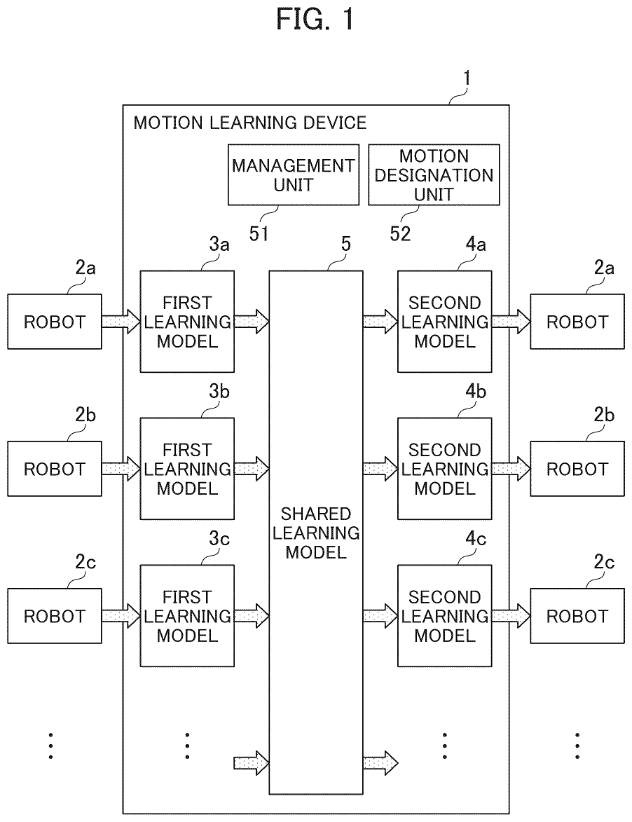

FIG. 1 illustrates a configuration example of a robot motion learning device 1 according to the present embodiment.

The present embodiment includes a plurality of types of robots 2a to 2c, a plurality of first learning models 3a to 3c, a plurality of second learning models 4a to 4c, a shared learning model 5, a management unit 51, and a motion designation unit 52.

The plurality of first learning models 3a to 3c receive motion information at a certain time and convert the motion information into motion features, and also receive external information at this time and convert the external information into external features, for the plurality of robots 2a to 2c.

The shared learning model 5 converts the motion features output by the first learning models 3a to 3c into predicted motion features at the next time that are common to the plurality of robots 2a to 2c, and also converts the external features output by the first learning models 3a to 3c into predicted external features at the next time that are common to the plurality of types of robots 2a to 2c.

The plurality of second learning models 4a to 4c convert, for the plurality types of robots 2a to 2c, the predicted motion features at the next time output by the shared learning model 5 into predicted motion information at the next time.

The management unit 51 uses teaching data related to the motion of each of the robots 2a to 2c to train either the first learning model and the second learning model related to one of the robots or the shared learning model 5.

When a plurality of motions are learned, the motion designation unit 52 selects a desired motion from the motion learning device 1 and causes each of the robots 2a to 2c to execute the motion.

The robots 2a to 2c are robots with which the desired motion acquired by the shared learning model 5 is to be shared, and there may be any number of such robots. The desired motion is a task or series of motions, for example, grasping an object in the field of view or opening and closing a door. This task may include, but is not limited to, manufacturing, maintenance, or housekeeping tasks, such as installing components, welding, painting, drilling, and the like.

The plurality of first learning models 3a to 3c correspond to the robots 2a to 2c, respectively, and receive information related to sensors mounted on the robots 2a to 2c and the robot states. Sensors include image and distance image sensors using imaging devices, lasers, and the like, sensors for forces applied to various parts of the robots 2a to 2c, and tactile sensors for measuring the state of contact with objects. In addition, information related to the state of the robots 2a to 2c includes the joint angles of the robots 2a to 2c, the current values of motors, and the like. The first learning models 3a to 3c receive these information of the robots 2a to 2c, learn and extract features related to the motion from the external (sensor) and internal (robot state) information, and output the resulting features to the shared learning model 5.

The shared learning model 5 is located between the plurality of first learning models 3a to 3c and the plurality of second learning models 4a to 4c. Regardless of the number of robots 2a to 2c, it is sufficient if there is one shared learning model 5 for a desired motion or task that is to be shared among the robots 2a to 2c. The shared learning model 5 learns a sequence of shared motions or tasks. The shared learning model 5 outputs future motion features to be transitioned from the motion features at the current time input from the first learning models 3a to 3c, and inputs the future motion features to the plurality of second learning models 4a to 4c. Here, the future motion features to be transitioned are basically the motion features at the next time in the control cycle of the robot. If the control cycles differ among the robots 2a to 2c, the control cycles are adjusted among the robots 2a to 2c by interpolation, synchronization, or the like. Note that in order to calculate the future motion features to be transitioned, it is sufficient to use the shortest control cycle among the robots 2a to 2c.

The second learning models 4a to 4c learn the relationship between the future motion features to be transitioned, which are input from the shared learning model 5, and the motions and control outputs for the corresponding robots 2a to 2c at that time, and output the resulting control outputs to the robots 2a to 2c. This causes each of the robots 2a to 2c to execute a sequence of desired motions or tasks.

### Hardware Configuration

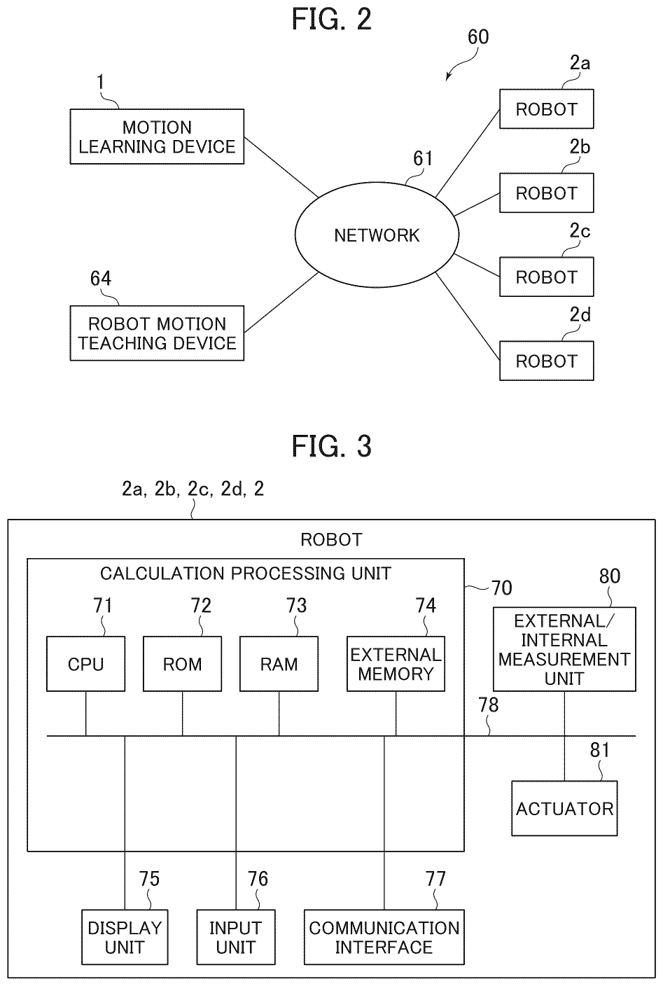

FIG. 2 illustrates an example of a configuration of a motion learning system 60 according to the present embodiment.

The motion learning system 60 according to the present embodiment in FIG. 2 includes the motion learning device 1, a plurality of types of robots 2a to 2d, a network 61, and a robot motion teaching device 64. As examples of the plurality of types of robots 2a to 2d, robots that work at construction sites, robots that work at manufacturing sites, and robots that perform household chores at home are assumed here, but the present invention is not limited thereto. The motion learning device 1 generates and stores a motion model that shares motions common to these robots 2a to 2d, such as the motion of grasping an object within the camera's field of view, and is capable of transferring a new shared motion learned by one robot to the motion of another robot.

The network 61 is the Internet, telephone network, or the like. The motion learning device 1 is, for example, an information processing device in which parameter and weight information, motion data of each robot, and teaching data are stored. Here, the weight information refers, for example, to the weights between network elements in a learning model. The motion learning device 1 operates in cooperation with a cloud server, a hard disk connected to a local area network (LAN), or the like. The plurality of types of robots 2a to 2d, the robot motion teaching device 64, and the motion learning device 1 are set up so as to be capable of accessing each other as appropriate.

The motion learning device 1 interfaces with a motion training administrator, accesses necessary information by communicating with the robots 2a to 2d and a server via the network 61, and trains a learning model. Note that the calculation itself may be performed using a server (not illustrated) connected to the network 61, and is not limited thereto.

In addition, the robot motion teaching device 64 is one form of means for acquiring the motion data of each of the robots 2a to 2d. The motion data of each robot includes external information detected by the sensors of each of the robots 2a to 2d, and internal information indicating the state of each of the robot 2a to 2d. Examples of the robot motion teaching device 64 include an augmented reality (AR) system using camera images mounted on the robots 2a to 2d, and a remote operation device that allows a person to remotely operate the robots 2a to 2d using a haptics system that presents reaction forces and tactile sensations acting on the robots 2a to 2d.

FIG. 3 illustrates an example of the hardware configuration of the robots 2a to 2d according to the present embodiment. Hereinafter, when there is no need to distinguish between the robots 2a to 2d, the robots 2a to 2d will simply be referred to as the robot 2.

The robot 2 includes a calculation processing unit 70, a communication interface 77, a display unit 75 and an input unit 76.

The calculation processing unit 70 includes a CPU 71, a ROM 72, a RAM 73, an external memory 74, and a system bus 78. The communication interface 77 is an interface with the network 61. The display unit 75 and the input unit 76 are an interface with the administrator. The calculation processing unit 70 executes a predetermined machine learning program and sets the configuration and parameters of the motion model downloaded from the motion learning device 1, thereby implementing the first learning model, the shared learning model, and the second learning model.

The CPU 71 is configured to execute overall information processing in the calculation processing unit 70, and controls other components via the system bus 78. The ROM 72 is a nonvolatile memory that stores control programs and the like required for the CPU 71 to execute processing. Note that the program may be stored in the external memory 74 or a removable storage medium. The RAM 73 is a volatile memory that operates as the main memory of the CPU 71 and functions as a work area or the like. In other words, when executing processing, the CPU 71 reads necessary programs and data from the ROM 72 or the external memory 74 into the RAM 73 and executes the programs to perform various functional motions.

The external memory 74 can store various data and information required for the CPU 71 to execute processing using a program, as well as the processing in progress and the results. The external memory 74 stores parameter and weight information, the robot's own motion data and teaching data, programs that implement the processing, the robot's own situation, and the like. The weight information is, for example, the weights between the network elements in the learning model.

The display unit 75 is composed of a monitor such as a liquid crystal display. The input unit 76 is configured to enable the administrator of the robot 2 to give instructions to the robot 2.

The communication interface 77 is an interface for communicating with external devices. In the present embodiment, the communication interface 77 communicates with the motion learning device 1, the robot motion teaching device 64, and the like. The communication interface 77 can be, for example, a wireless communication local area network (LAN) interface or a wired communication LAN interface. The system bus 78 connects the CPU 71, the ROM 72, the RAM 73, the external memory 74, the display unit 75, the input unit 76, the communication interface 77, an external/internal measurement unit 80, and an actuator 81 to allow communication therebetween.

The external/internal measurement unit 80 is composed of various sensors. Examples of external sensors of the robot 2 include image sensors and distance image sensors using imaging devices, lasers, and the like, sensors for measuring forces and torques applied to various parts of the robot 2, and tactile sensors for measuring the state of proximity and contact state between the robot 2 and an object. Examples of internal sensors of the robot 2 include angle sensors that measure the joint angles of the robot 2, and motor voltage and current sensors. The configurations, performance, output format, and the like of these sensors vary according to the robot 2. Therefore, the present invention is configured to enable the sharing and transfer of learning information and learning models among such different robots. High-quality motion acquired by one robot is shared and transferred to other robots that have not yet learned the motion. This allows a reduction in training load, such as obtaining teaching data and tuning parameters, and facilitates the acquisition of high-quality motion. The external/internal measurement unit 80 is also an essential component of the robot motion teaching device 64. The robot motion teaching device 64 measures the installed switches, the angle and pressure of movable mechanisms, and the like, and operates the robot 2 on the basis of the information.

The actuator 81 is composed of an actuator that moves a hardware mechanism and electronic components that control the output of the actuator. Examples of the actuator 81 include motors, which are rotary elements using electromagnetic force, solenoids, which are linear motion elements, and vibration elements such as piezoelectric elements. In the robot 2, the actuator 81 is used for wheels, arm joints, opening/closing of hands, camera pan-tilt, and the like. The robot 2 have various mechanisms, such as the number of joints, arm length, and number of fingers on the hand. The present invention enables the sharing and transfer of learning information and learning models among such different robots, so that the high-quality motion acquired by one robot can be shared and transferred to other robots that have not yet learned the motion. This allows a reduction in training load, such as obtaining teaching data and tuning parameters, and facilitates the acquisition of high-quality motion. The robot motion teaching device 64 is also provided with an actuator when presenting reaction forces or tactile sensations applied to the robot 2.

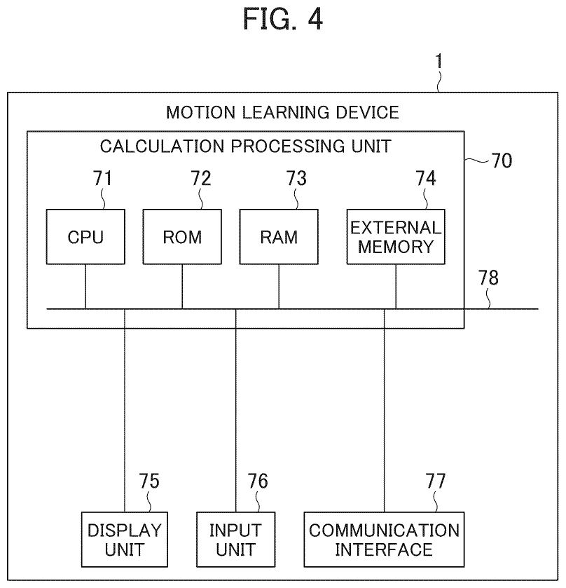

FIG. 4 is an example of the hardware configuration of the motion learning device 1 according to the present embodiment.

The motion learning device 1 includes the calculation processing unit 70, the communication interface 77, the display unit 75, and the input unit 76.

The calculation processing unit 70 includes a CPU 71, a ROM 72, a RAM 73, an external memory 74, and a system bus 78. The communication interface 77 is an interface with the network 61. The display unit 75 and the input unit 76 are an interface with the administrator.

The CPU 71 is configured to execute overall information processing in the calculation processing unit 70, and controls other components via the system bus 78. The ROM 72 is a nonvolatile memory that stores control programs and the like required for the CPU 71 to execute processing. Note that the program may be stored in the external memory 74 or a removable storage medium. The RAM 73 is a volatile memory that operates as the main memory of the CPU 71 and functions as a work area or the like. In other words, when executing processing, the CPU 71 reads necessary programs and data from the ROM 72 or the external memory 74 into the RAM 73 and executes the programs to perform various functional motions.

The external memory 74 can store various data and information required for the CPU 71 to execute processing using a program, as well as the processing in progress and the results. The external memory 74 stores the configuration information of the motion learning device 1, parameter and weight information, the motion data and teaching data for each of the robots 2a to 2d, programs that implement the processing, the situation of each of the robots 2a to 2d, and the like. The weight information is, for example, the weights between the network elements in the learning model.

The display unit 75 is composed of a monitor such as a liquid crystal display. The input unit 76 is composed of a keyboard, and a pointing device such as a mouse. The input unit 76 is configured to enable the administrator to check information from each device and give instructions.

The communication interface 77 is an interface for communicating with external devices. In the present embodiment, the communication interface 77 communicates with the plurality of types of robots 2a to 2c, the robot motion teaching device 64, and the like. The communication interface 77 can be, for example, a wireless communication local area network (LAN) interface or a wired communication LAN interface. The system bus 78 connects the CPU 71, the ROM 72, the RAM 73, the external memory 74, the display unit 75, the input unit 76, and the communication interface 77 to allow communication therebetween.

### One Example of Detailed Configuration of Motion Learning Device 1

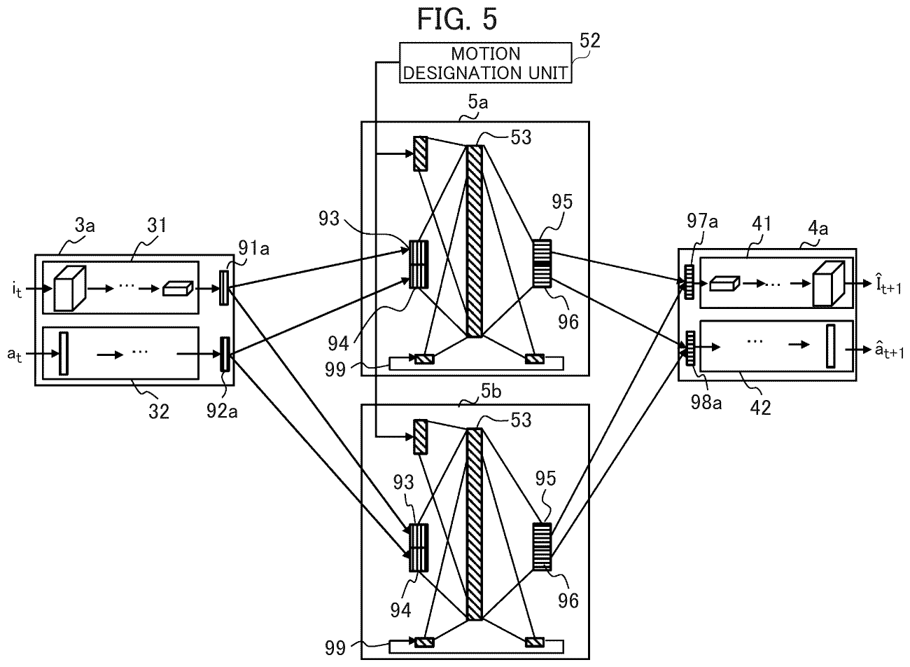

Hereinafter, one example of the detailed configuration of the motion learning device 1 will be described with reference to FIGS. 5 to 7. FIGS. 5 to 7 illustrate the interior of the system configuration example in FIG. 1 in more details.

FIG. 5 illustrates an example of the detailed configuration and operation of the first learning model 3a and the second learning model 4a for the robot 2a, and the shared learning models 5a and 5b that share the learning results of the robots 2a to 2d.

The first learning model 3a includes machine learning models 31 and 32. The machine learning models 31 and 32 include, for example, the configuration of a convolutional neural network (CNN) or an autoencoder (AE). The autoencoder (AE), which constitutes the machine learning models 31 and 32, refers to a configuration in which information is reduced in multiple fully connected layers while reducing the number of elements in a neural net.

The first learning model 3a of the robot 2a receives input of image information iₜ, which is external information, from a camera, and robot motion information aₜ, which is internal information, from joint angle sensors.

The machine learning model 31 extracts external features 91a from the image information iₜ, which is external information. The machine learning model 32 extracts internal features 92a from the robot motion information aₜ, which is internal information.

The shared learning models 5a and 5b each include, for example, a learning model 53 that learns time-series information with a recursive loop 99 such as a recurrent neural network (RNN) or a long short-term memory (LSTM). The learning model 53 acquires motion sequences and motion models. Here, an example of the RNN is shown.

The learning model 53, which is an RNN, outputs the features at a future time (t+1) to be transitioned from the features at a current time t. The external features 91a output from the first learning model 3 are connected one-to-one to external features 93 on the input side of the shared learning models 5a and 5b. The internal features 92a output from the first learning model 3 are connected one-to-one to internal features 94 on the input side of the shared learning models 5a and 5b. Since the plurality of types of robots 2a do not use the same motion learning device 1 at the same time, both in the learning process and in the execution process, this connection is switched on a robot-by-robot basis for use. Note that the first learning model 3a and the second learning model 4a are specific to this robot 2a.

Predicted external features 95 on the output side of the shared learning models 5a and 5b are connected one-to-one to predicted external features 97a of the robot 2a. Predicted internal features 96 on the output side of the shared learning models 5a and 5b are connected one-to-one to predicted internal features 98a of the robot 2a.

The second learning model 4 includes machine learning models 41 and 42. The machine learning model 41 is configured with a multi-layer connection while increasing the number of elements in the neural network, the opposite of the machine learning model 31. The machine learning model 41 generates a predicted value of external information (iₜ₊₁) at the next time from the features. The machine learning model 42 generates a predicted value of robot motion information (aₜ₊₁) at the next time from the features. The only information related to the robot motion among the outputs of the second learning model 4 is the robot motion information (aₜ₊₁), but from the perspective of learning, the predicted value of the external information (iₜ₊₁) is also output.

The motion designation unit 52 selects either the shared learning model 5a or 5b by providing a value corresponding to one of the motions to a parametric bias node trained to have one value for one motion. When the motion designation unit 52 provides a value corresponding to a desired motion to the parametric bias node, the desired motion can be selected from the motion learning device 1 that has learned a plurality of motions, to execute the motion of the robot 2.

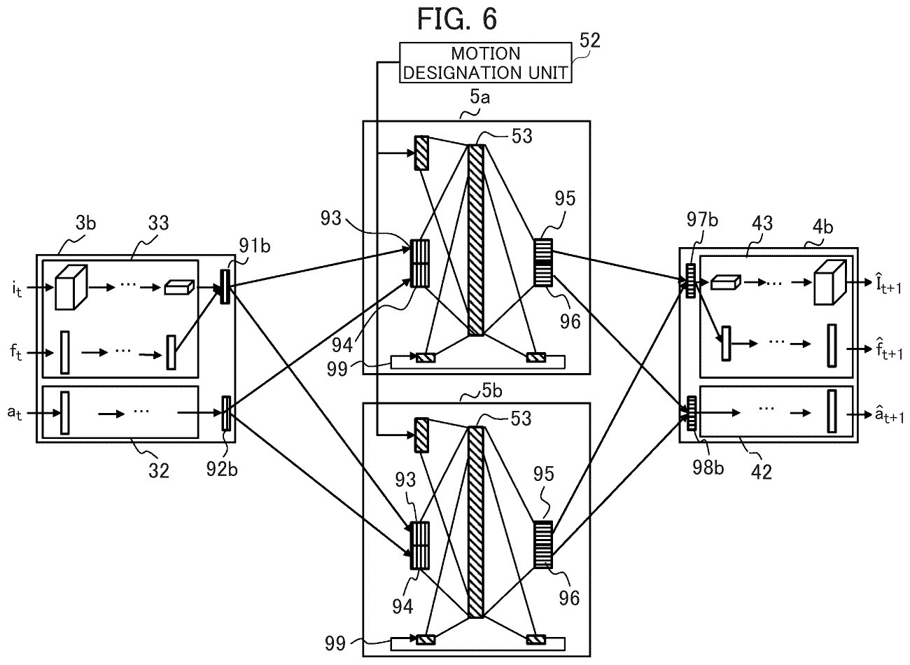

FIG. 6 illustrates an example of the detailed configuration and operation of a first learning model 3b and a second learning model 4b for the robot 2b, and the shared learning models 5a and 5b that share the learning results of the robots 2a to 2d.

The first learning model 3b includes machine learning models 33 and 32.

The machine learning model 33 of the first learning model 3b of the robot 2b receives input of force-tactile information fₜ, which is external information, in addition to the image information iₜ from the camera. Upon receiving the image information iₜ and the force-tactile information fₜ, the machine learning model 33 outputs external features 91b through the fully connected layers.

The robot motion information aₜ input to the machine learning model 32 includes, although not shown in the figure, information from motor current sensors and the like in addition to the joint angles of the robot 2b. The machine learning model 32 outputs internal features 92b upon receiving the robot motion information aₜ.

The machine learning model 33 extracts the external features 91b from the image information iₜ and the force-tactile information fₜ, which are external information. The machine learning model 32 extracts the internal features 92b from the robot motion information aₜ, which is internal information.

The shared learning models 5a and 5b each include the learning model 53 that learns time-series information with the recursive loop 99 such as an RNN or LSTM. The learning model 53 acquires motion sequences and motion models. Here, an example of the RNN is shown.

The learning model 53, which is an RNN, outputs the features at a future time (t+1) to be transitioned from the features at a current time t. The external features 91b output from the first learning model 3 are connected one-to-one to the external features 93 on the input side of the shared learning models 5a and 5b. The internal features 92b output from the first learning model 3 are connected one-to-one to the internal features 94 on the input side of the shared learning models 5a and 5b. Since the plurality of types of robots 2b do not use the same motion learning device 1 at the same time, both in the learning process and in the execution process, this connection is switched on a robot-by-robot basis for use. Note that the first learning model 3b and the second learning model 4b are specific to the robot 2b.

The predicted external features 95 on the output side of the shared learning models 5a and 5b are connected one-to-one to predicted external features 97b of the robot 2b. The predicted internal features 96 on the output side of the shared learning models 5a and 5b are connected one-to-one to predicted internal features 98b of the robot 2b.

The second learning model 4b includes machine learning models 43 and 42. The machine learning model 43 is configured with a multi-layer connection while increasing the number of elements in the neural network, the opposite of the machine learning model 33. The machine learning model 43 generates predicted values of the image information (iₜ₊₁) and force-tactile information (fₜ₊₁), which are the external information at the next time, from the predicted external features 97b. The machine learning model 42 generates a predicted value of the robot motion information (aₜ₊₁) at the next time from predicted internal features 98c. The only information related to the motion of the robot 2b among the outputs of the second learning model 4b is the robot motion information (aₜ₊₁), but from the perspective of learning, the predicted values of the image information (iₜ₊₁) and the force-tactile information (fₜ₊₁), which are external information, are also output.

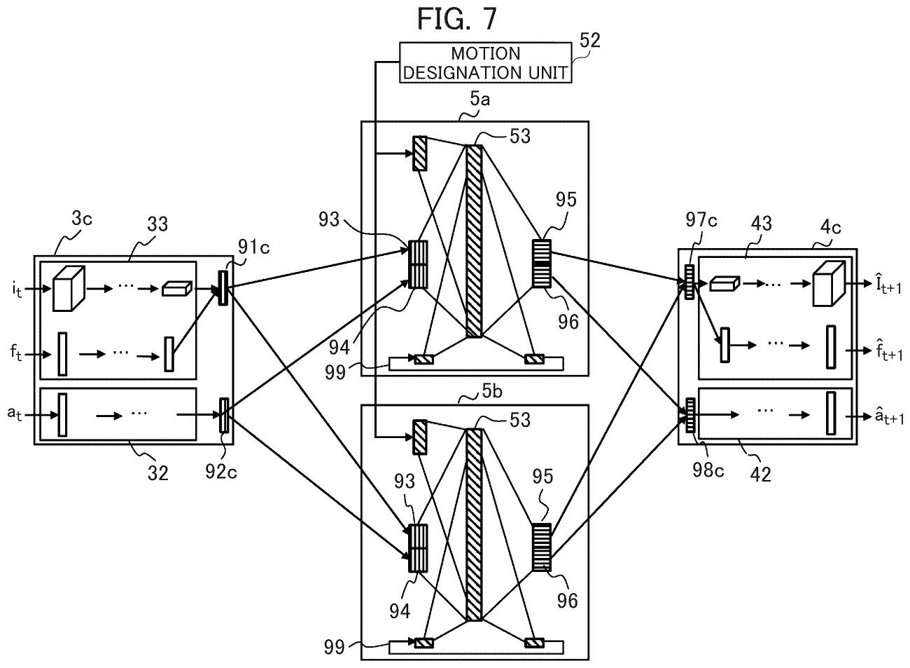

FIG. 7 illustrates an example of the detailed configuration and operation of the first learning model 3c and the second learning model 4c for the robot 2c, and the shared learning models 5a and 5b that share the learning results of the robots 2a to 2d.

The first learning model 3c includes the machine learning models 33 and 32.

The machine learning model 33 of the first learning model 3c of the robot 2c receives input of the force-tactile information fₜ, which is external information, in addition to the image information iₜ from the camera. Upon receiving the image information iₜ and the force-tactile information fₜ, the machine learning model 33 outputs external features 91c through the fully connected layers.

The robot motion information aₜ input to the machine learning model 32 includes, although not shown in the figure, information from motor current sensors and the like in addition to the joint angles of the robot 2c. The machine learning model 32 outputs internal features 92c upon receiving the robot motion information aₜ.

The machine learning model 33 extracts the external features 91c from the image information iₜ and the force-tactile information fₜ, which are external information. The machine learning model 32 extracts the internal features 92c from the robot motion information aₜ, which is internal information.

The shared learning models 5a and 5b each include the learning model 53 that learns time-series information with the recursive loop 99 such as an RNN or LSTM. The learning model 53 acquires motion sequences and motion models. Here, an example of the RNN is shown.

The learning model 53, which is an RNN, outputs the features at a future time (t+1) to be transitioned from the features at a current time t. The external features 91c output from the first learning model 3 are connected one-to-one to the external features 93 on the input side of the shared learning models 5a and 5b. The internal features 92c output from the first learning model 3 are connected one-to-one to the internal features 94 on the input side of the shared learning models 5a and 5b. Since the plurality of types of robots 2c do not use the same motion learning device 1 at the same time, both in the learning process and in the execution process, this connection is switched on a robot-by-robot basis for use. Note that the first learning model 3c and the second learning model 4c are specific to the robot 2c.

The predicted external features 95 on the output side of the shared learning models 5a and 5b are connected one-to-one to predicted external features 97c of the robot 2c. The predicted internal features 96 on the output side of the shared learning models 5a and 5b are connected one-to-one to the predicted internal features 98c of the robot 2c.

The second learning model 4c includes the machine learning models 43 and 42. The machine learning model 43 is configured with a multi-layer connection while increasing the number of elements in the neural network, the opposite of the machine learning model 33. The machine learning model 43 generates predicted values of the image information (iₜ₊₁) and the force-tactile information (fₜ₊₁), which are the external information at the next time, from the predicted external features 97c. The machine learning model 42 generates a predicted value of the robot motion information (aₜ₊₁) at the next time from predicted internal features 98c. The only information related to the motion of the robot 2c among the outputs of the second learning model 4c is the robot motion information (aₜ₊₁), but from the perspective of learning, the predicted values of the image information (iₜ₊₁) and the force-tactile information (fₜ₊₁), which are external information, are also output.

Here, the external features 91a to 91c illustrated in FIGS. 5 to 7 have the same number of neuron elements so that the external features 91a to 91c have the same amount of information. The internal features 92a to 92c also have the same number of neuron elements so that the internal features 92a to 92c have the same amount of information. With this configuration, the same information can be obtained in situations where task sequences are the same, even if the configuration of the robot 2 is different.

### Overall Learning Processing

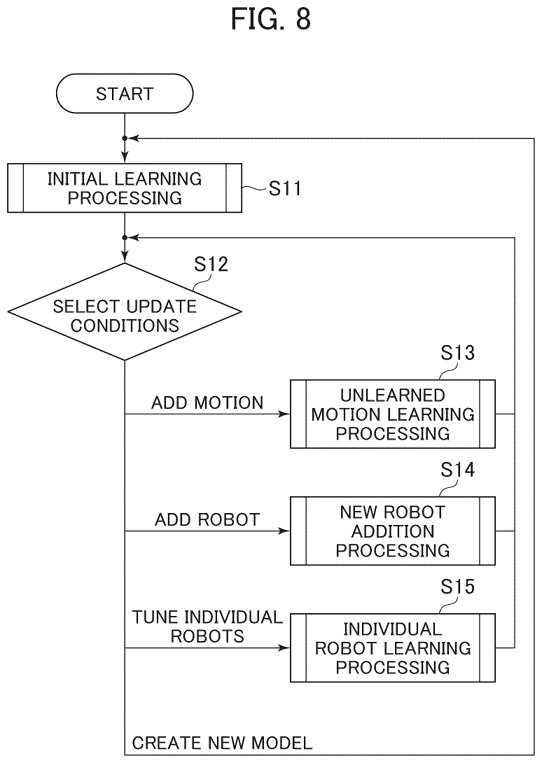

FIG. 8 is a flowchart of learning processing of the motion learning device 1.

First, the management unit 51 executes initial learning processing for the robots 2a to 2c to obtain initial motion models (step S11).

Next, in step S12, the management unit 51 branches and shifts to four steps, depending on the selection of update conditions.

If the addition of a motion is requested in step S12, the management unit 51 executes learning processing for unlearned motion (step S13), and the processing returns to step S12.

If the addition of a robot is requested in step S12, the management unit 51 executes processing for adding a new robot (step S14), and the processing returns to step S12.

If individual tuning is requested for each robot in step S12, the management unit 51 executes learning processing for individual robots (step S15), and the processing returns to step S12.

If the management unit 51 detects a combination of robots different from the robots 2a to 2c, or a significant change in the configuration of a plurality of types of robots, the processing returns to step S11, where initial learning processing for creating a new model is executed (step S11).

### Initial Learning Processing

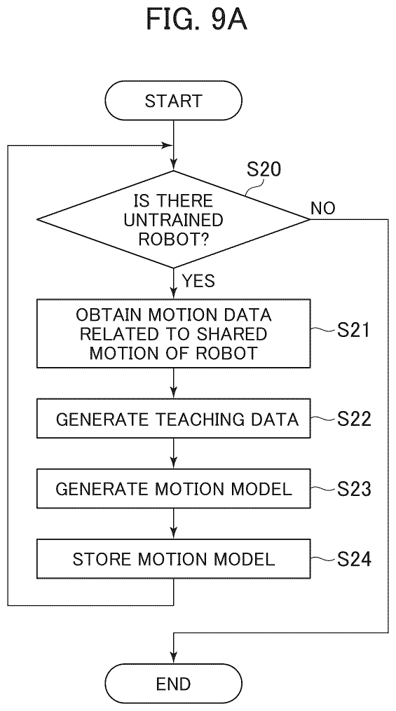

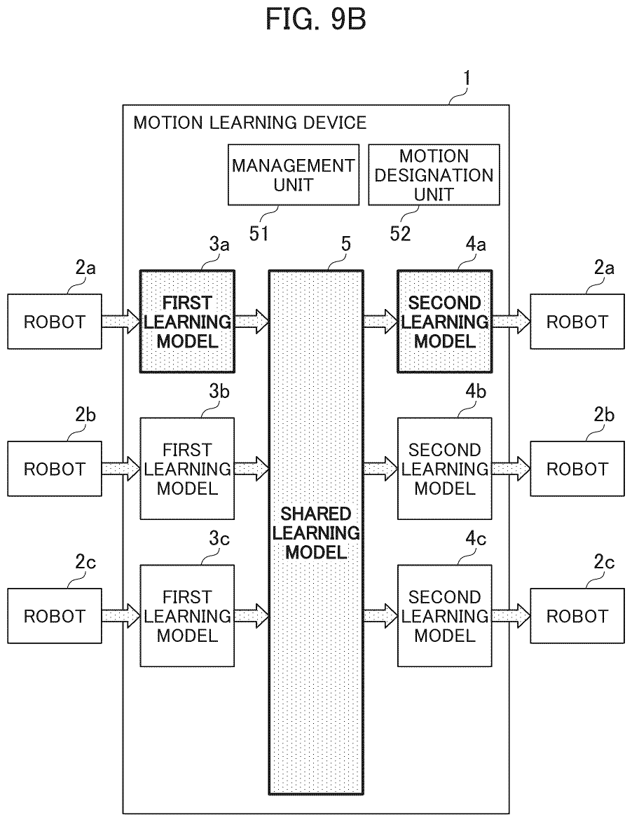

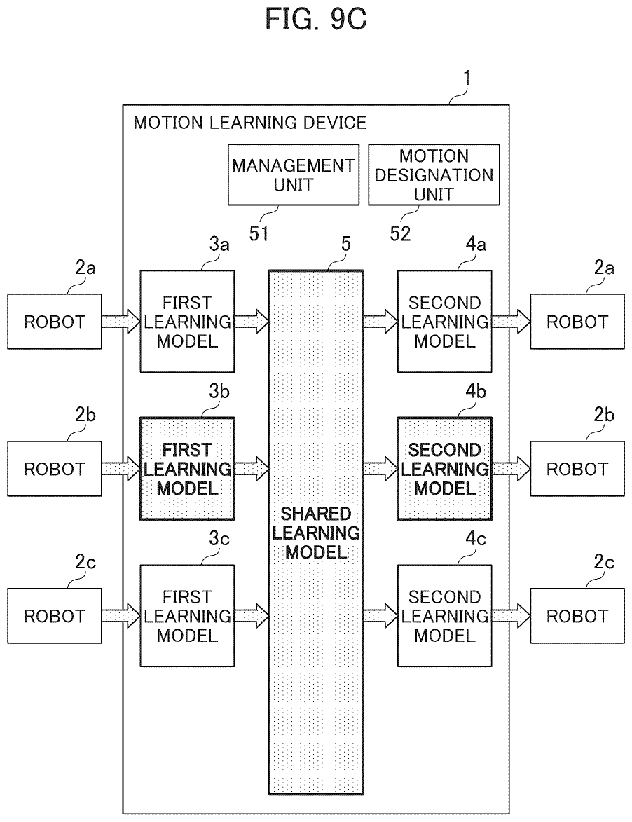

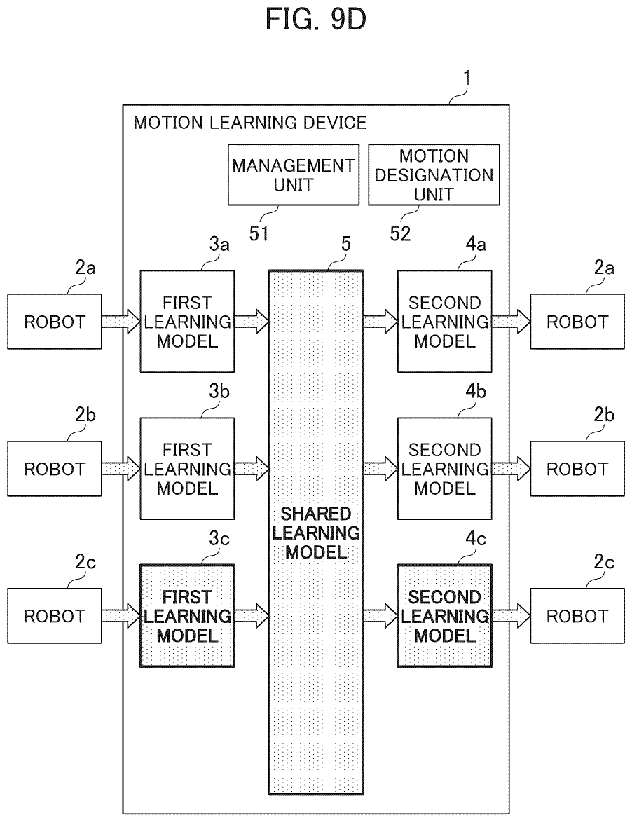

Hereinafter, the initial learning processing of the motion learning device 1 will be described with reference to FIGS. 9A to 9D.

The initial learning processing in FIG. 9A is processing for teaching the robot to execute a desired shared motion, such as “grasping a component,” and acquiring an initial motion model. Here, shared motions are those that are basic and of low difficulty. The motion model is a trained learning model that has acquired the desired motion, that is, a learning model that can be used in the execution of the desired motion by the robot 2.

The management unit 51 determines the presence or absence of an untrained robot (step S20). If there is no untrained robot (No), the processing in FIG. 9A ends. If there is an untrained robot (Yes), the processing proceeds to step S21.

First, in step S21, the management unit 51 causes an untrained robot, which serves as an object to be controlled, to execute a desired shared motion, such as grasping a predetermined component, and obtains motion data related to the shared motion of this robot. Here, the desired shared motion is a basic motion or a motion with a low level of difficulty, and all the robots are made to execute the same motion. The management unit 51 detects and obtains, as robot motion data, external information of this robot via sensors, and further obtains robot state information, which is internal information of this robot.

The management unit 51 obtains robot motion data by employing a method for remotely controlling the robot 2 to execute a motion using a remote operation device, a direct teaching method in which a person directly holds the robot to execute a motion, a method in which a person pre-programs a motion and replays the motion, a method using simulation together, or the like.

The management unit 51 generates teaching data for training the learning model of the motion learning device 1 from the motion data obtained in step S21 (step S22). During learning by the learning model of the motion learning device 1, the teaching data is used in the learning process in which the parameters in the learning model are changed so as to reduce the error, on the basis of an evaluation function using the error between the teaching data and the output of the learning model. The parameters in the learning model are, for example, the weights between the network elements in the learning model.

Part of the teaching data is evaluation data used in the process of determining the convergence of learning by the learning model. The learning convergence means that the error between the teaching data and the output of the learning model becomes equal to or smaller than a predetermined value. The teaching data is a set of input teaching data, which is the motion data at a certain time, and output teaching data, which is the motion data at the next time in the control cycle, for all the acquired motion data.

If the working time or control cycle differs between robots, the management unit 51 normalizes the working time or adjusts the cycle (interpolation, synchronization) to generate the teaching data.

The management unit 51 uses the teaching data generated in step S22 to train the learning model of the motion learning device 1 and generate a motion model (step S23).

The management unit 51 provides input teaching data to the first learning models 3a to 3c corresponding to the robot 2a to 2c, respectively. The management unit 51 uses the error between the output of the second learning models 4a to 4c corresponding to the robots 2a to 2c at that time and the output teaching data to change the parameters of the learning models corresponding to the robots 2a to 2c. The parameters in the learning model are, for example, the weights between the network elements in the learning model.

In FIG. 9B, the first learning model 3a and the second learning model 4a corresponding to the robot 2a, and the shared learning model 5 where learning is simultaneously performed, are illustrated by hatching.

In FIG. 9C, the first learning model 3b and the second learning model 4b corresponding to the robot 2b, and the shared learning model 5 where learning is simultaneously performed, are illustrated by hatching.

In FIG. 9D, the first learning model 3c and the second learning model 4c corresponding to the robot 2c, and the shared learning model 5 where learning is simultaneously performed, are illustrated by hatching.

These processes are repeated until the convergence of learning is achieved, using all the teaching data obtained for all the robots 2a to 2c. As a result, a motion model is generated.

Returning to FIG. 9A, the explanation will be continued. The management unit 51 stores the motion model generated in step S23 (step S24). The data stored by the management unit 51 as the motion model is the configuration information constituting the learning model of the motion learning device 1, which will be described later, and parameter and weight information.

The management unit 51 stores the first learning model 3a and the second learning model 4a illustrated in FIG. 9B, and the shared learning model 5, where learning is simultaneously performed, in the robot 2a as the motion model.

The management unit 51 stores the first learning model 3b and the second learning model 4b illustrated in FIG. 9C, and the shared learning model 5, where learning is simultaneously performed, in the robot 2b as the motion model.

The management unit 51 stores the first learning model 3c and the second learning model 4c illustrated in FIG. 9D, and the shared learning model 5, where learning is simultaneously performed, in the robot 2c as the motion model.

The configurations of the robots 2a to 2c may differ, for example, in the robot mechanism, image sensor, and force-tactile sensor, and may include or not include sensors. In this way, by learning with many robots/various types of robots, common information related to desired motions is learned and accumulated in the shared learning model 5. The input information processing specific to each robot is automatically separated, learned, and accumulated in the first learning model 3. The output information processing specific to each robot is automatically separated, learned, and accumulated in the second learning model 4.

### Learning Processing for Unlearned Motion

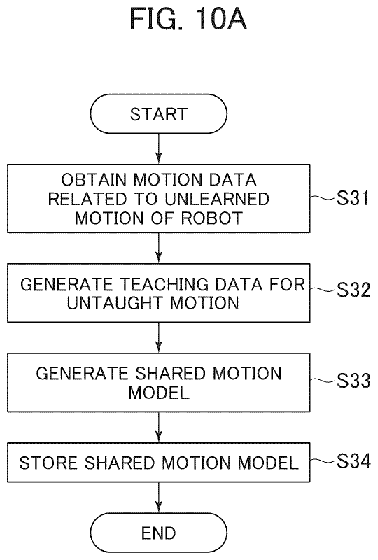

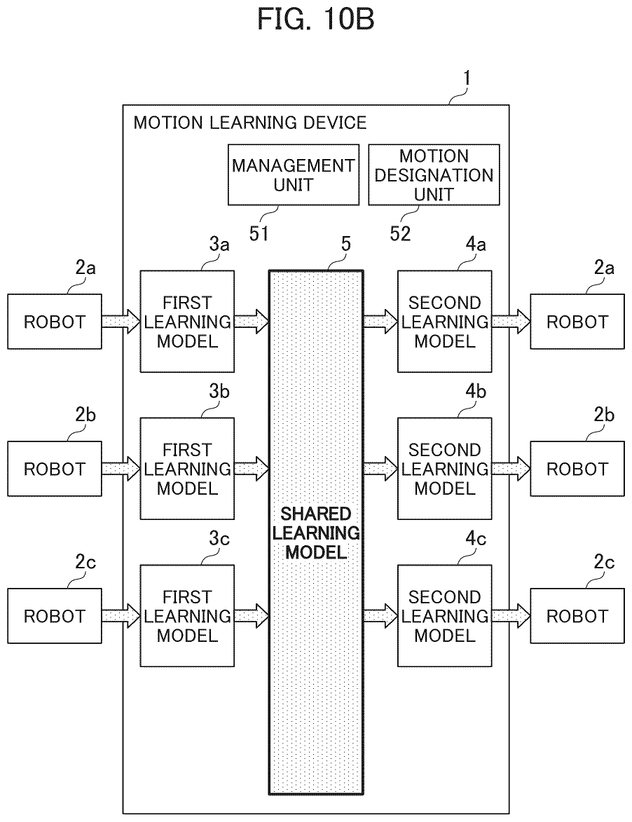

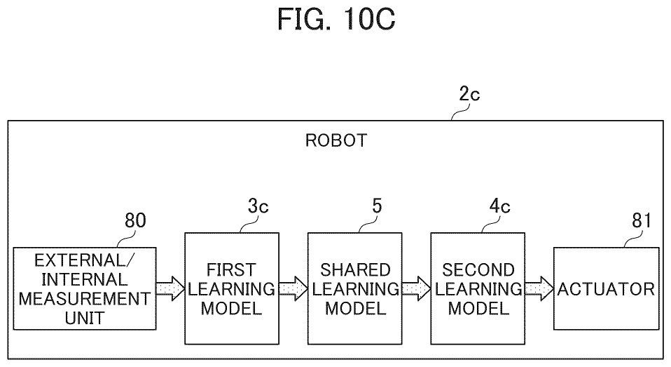

Hereinafter, the unlearned motion learning processing of the motion learning device 1 will be described with reference to FIGS. 10A to 10C. The management unit 51 uses teaching data related to motion that has not been learned by each of the robots 2a to 2c, to train the shared learning model 5 while keeping the parameters of the first learning models 3a to 3c and the second learning models 4a to 4c fixed. This allows a reduction in the training load on the learning model.

The basic flow of the learning processing for unlearned motion in FIG. 10A is the same as the initial learning processing in FIG. 9A, but the part to be trained is different. For simplicity, a case in which the motion model acquired by the robot 2a is transferred to the untrained robot 2c will be described here. This combination is for convenience, and the motion model acquired by the robot 2a may be transferred to the untrained robots 2b and 2c, or the model acquired by the robots 2a and 2b may be transferred to the untrained robot 2c.

First, the management unit 51 uses, for example, the robot 2a to execute a desired unlearned shared motion, and obtains the motion data of the robot 2a (step S31). As the motion data of the robot 2a, the external information of the robot 2a is detected via sensors, and the robot state, which is the internal information of the robot 2a, is obtained.

In the initial learning processing, motion data is acquired for all the robots 2a to 2c to be used, but in the learning processing for unlearned motion, motion data for all of the robots 2a to 2c is not necessary. It is sufficient to acquire motion data with one or more types of robots that can perform relatively easily or acquire high-quality motion.

The management unit 51 generates teaching data for training the learning model of the motion learning device 1 from the motion data obtained in step S31 (step S32). This teaching data generation processing is similar to step S22 of the initial learning processing.

The management unit 51 uses the teaching data generated in step S32 to train the motion learning device 1 to generate a motion model (step S33). The management unit 51 provides input teaching data to the first learning model 3a corresponding to the robot 2a and uses the error between the output of the second learning model 4a corresponding to the robot 2a and the output teaching data to change the parameters of the shared learning model 5 indicated by the hatched part in FIG. 10B. At the same time, the management unit 51 fixes the parameters of the first learning model 3a and the parameters of the second learning model 4a.

In the initial learning processing, the management unit 51 trains the learning models in the hatched parts corresponding to the robots 2a to 2c, as illustrated in FIG. 9B to FIG. 9D. At the time of the learning processing for unlearned motion, the management unit 51 has trained the first learning models 3a to 3c and second learning models 4a to 4c of the robots 2a to 2c. Therefore, for new motions, it is sufficient if only the sequence of shared motions is learned. Therefore, the management unit 51 trains only the shared learning model 5 in step S33.

The management unit 51 stores the shared learning model 5 generated in step S33 as a motion model in the robot (step S34). More specifically, the management unit 51 stores the shared learning model 5 as a motion model in the robot 2c in order to cause the robot 2c to execute this unlearned motion. This allows the robot 2c to execute unlearned motions that the robot 2c has no experience of executing, in the configuration illustrated in FIG. 10C, using the first learning model 3c and the second learning model 4c in addition to the newly-stored shared learning model 5. At this time, sensing data from the external/internal measurement unit 80 of the robot 2c is input to the first learning model 3c, and the actuator 81 of the robot 2c is driven on the basis of the predicted motion information output via the shared learning model 5 and the second learning model 4c.

According to the learning processing for unlearned motion, motion using a robot that can easily acquire the desired motion or that can acquire high-quality motion, or motion of a robot that has accidentally acquired high-quality motion can be transferred to other robots, so that high-quality motion can be easily acquired.

In addition, since the management unit 51 re-trains the shared learning model 5 in this learning processing, the initial values used in the initial training may be used as the initial values for retraining, or the initialized values may be used for new training. By training and accumulating a new shared learning model 5 for each desired motion, a plurality of motion models for the corresponding motions can be acquired, and the desired motion can be achieved by selecting the corresponding one of the motion models at the time of executing.

### New Robot Addition Processing

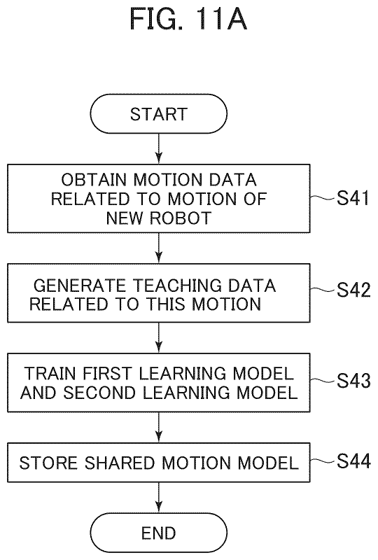

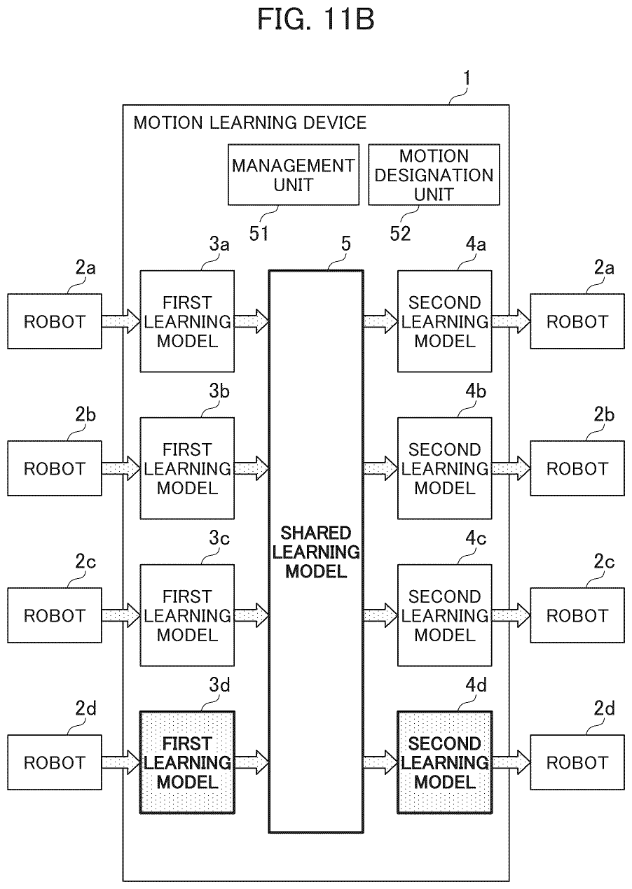

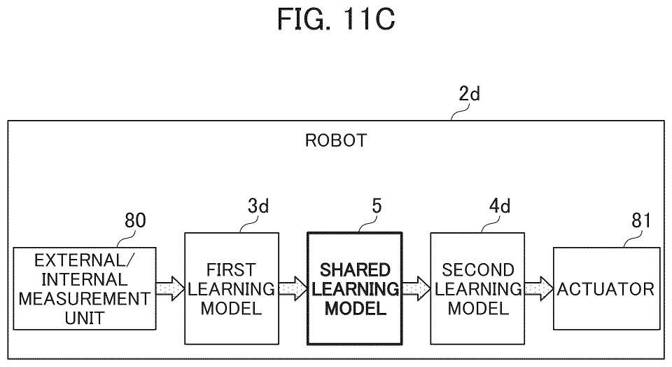

Hereinafter, new robot addition processing of the motion learning device 1 will be described with reference to FIGS. 11A to 11C.

The management unit 51 newly adds the first learning model 3d and second learning model 4d corresponding to the robot 2d to be newly added as an object to be controlled. Then the management unit 51 uses teaching data for the robot 2d to be newly added, related to the motion that the shared learning model 5 has already learned, to train the first learning model 3d and the second learning model 4d while keeping the parameters of the shared learning model 5 fixed.

The basic flow of the new robot addition processing in FIG. 11A is the same as the initial learning processing in FIG. 9A, but the part to be trained is different. Here, as illustrated in FIG. 11B, the management unit 51 trains the first learning model 3d and second learning model 4d associated with the newly added robot 2d. Even the existing robots 2a to 2c are desirably treated as new robots if their configurations have been changed due to sensor replacement, hand replacement, or the like.

First, the management unit 51 causes the new robot 2d to execute the shared motion already learned by the shared learning model 5, and obtains robot motion data (step S41). In the initial learning processing, motion data is acquired for all robots to be used, but here, only the motion data of the new robot 2d is obtained.

The management unit 51 generates teaching data for training the learning model of the motion learning device 1 from the motion data obtained in step S41 (step S42). This processing is similar to step S22 of the initial learning processing.

The management unit 51 uses the teaching data generated in step S42 to train the first learning model 3d and the second learning model 4d, which are part of the motion learning device 1 (step S43). The management unit 51 provides input teaching data to the first learning model 3d corresponding to the robot 2d and uses the error between the output of the second learning model 4d corresponding to the robot 2d at that time and the output teaching data to change the parameters of the first learning model 3d and the second learning model 4d. In the initial learning processing, the hatched parts corresponding to the robots 2a to 2c illustrated in FIGS. 9B to 9D are trained, but in the new robot addition processing, the first learning models 3a to 3c and second learning models 4a to 4c associated with the existing robots 2a to 2c, and the shared learning model 5, have already been trained. Therefore, for adding the new robot 2d, only the first learning model 3d and second learning model 4d of the newly added robot 2d need to be trained, using the sequence of shared motions already learned by the shared learning model 5.

The management unit 51 stores the first learning model 3d and the second learning model 4d generated in step S43, in the robot 2d as the motion model, and stores the shared learning model 5 in the robot 2d as the motion model (step S44). This allows the robot 2d to execute the shared learning motion already learned by the other robots 2a to 2c, in the configuration illustrated in FIG. 11C, using the shared learning model 5 composed of the stored motion models.

FIG. 11C illustrates the configuration of the newly added robot 2d. At this time, sensing data from the external/internal measurement unit 80 is input to the first learning model 3d, and the actuator 81 is driven on the basis of the predicted motion information output via the shared learning model 5 and the second learning model 4d.

This allows a reduction in the training load and also makes it possible for the newly added robot 2d to execute high-quality motion that has already been acquired by the other robots 2a to 2c.

### Individual Robot Learning Processing

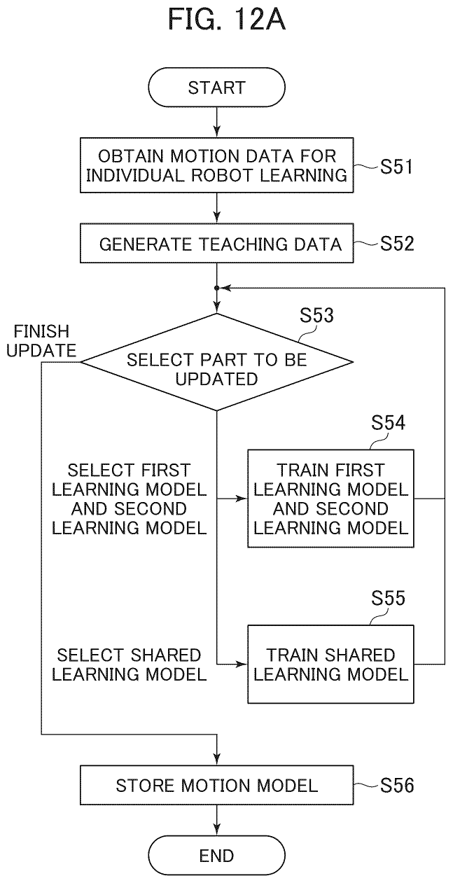

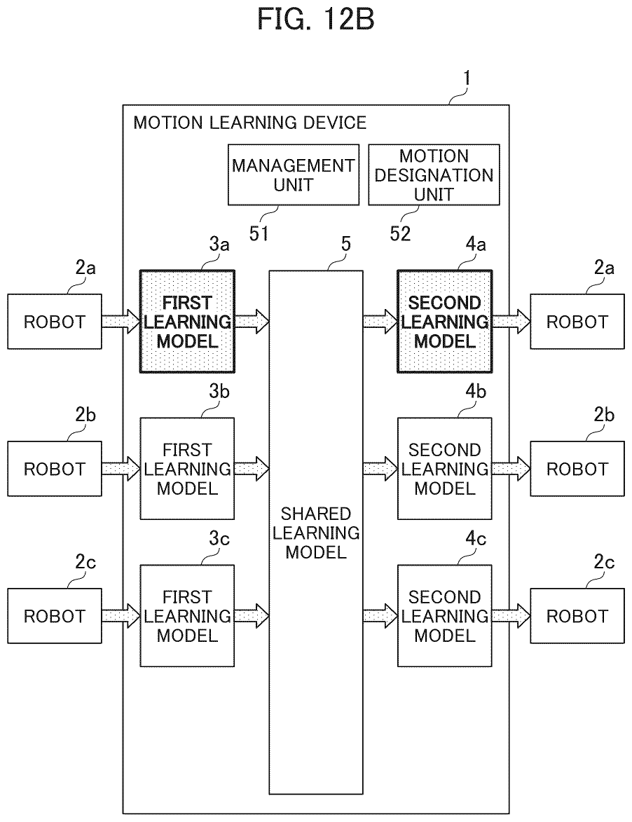

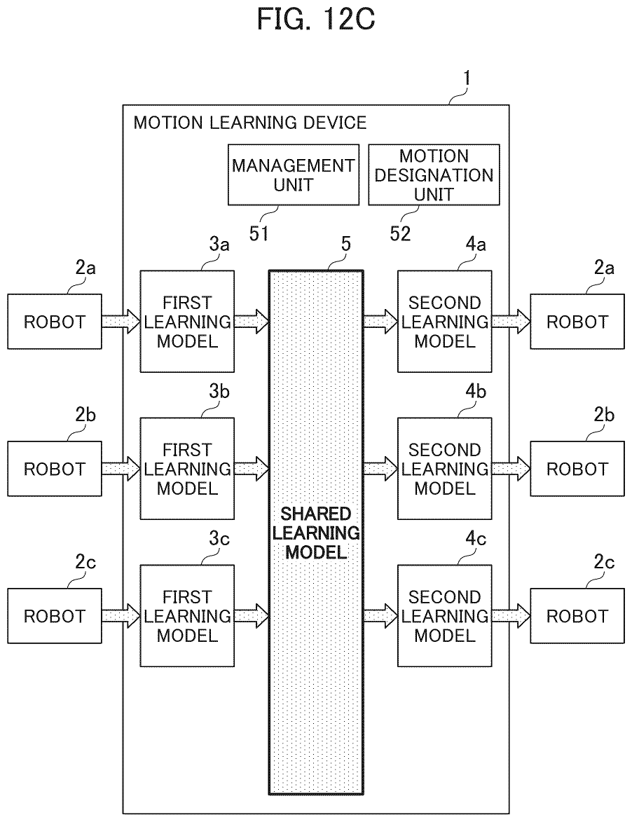

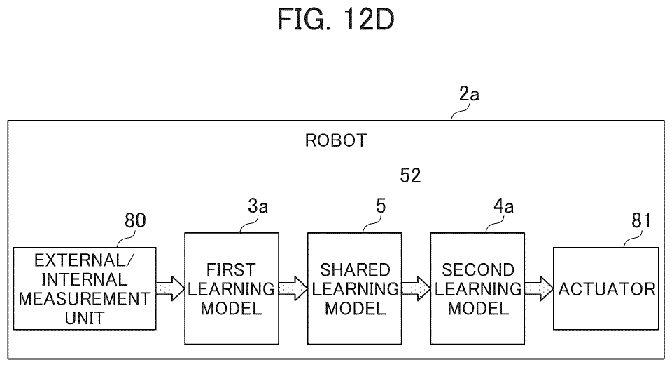

Hereinafter, the individual robot learning processing of the motion learning device 1 will be described with reference to FIGS. 12A to 12D. Here, tuning is performed on the already trained robots 2a to 2c to improve the sensitivity of sensing, the quality, accuracy, and success rate of motion, and the like. Here, tuning refers to minute parameter adjustments, retraining, additional training, and the like, for an existing learning model.

Upon newly obtaining teaching data for a robot, related to the shared motion already learned by the shared learning model 5, the management unit 51 uses the teaching data to perform either first training in which only the first learning model and the second learning model corresponding to this robot are trained or second training in which only the shared learning model 5 corresponding to the shared motion is trained, or alternate between the first training and the second training.

The processing of each part constituting the individual robot learning processing in FIG. 12A is similar to the processing described above, but the training conditions are different. Here, the robot 2a will be described as an object to be controlled.

First, the management unit 51 causes the robot 2a to execute the shared motion already learned by the shared learning model 5, and obtains the motion data of the robot 2a (step S51). The method for obtaining motion data is similar to in step S21 in FIG. 9A. Since the goal here is to improve performance, the management unit 51 collects motion data that is expected to improve quality, such as motion with a high success rate, motion that is robust to the environment, and motion that could be properly handled by sensing.

The management unit 51 may repeatedly collect motion data and select high-quality data from thereamong, or at the stage of accidental acquisition of high-quality motion, the data may be used for tuning in step S21. Note that if the shared learning model 5 is updated by another robot and only the first learning model 3a and second learning model 4a of the robot 2a are desired to be updated accordingly, the management unit 51 may use existing motion data used in the past.

The management unit 51 generates teaching data for training the motion learning device 1 from the motion data obtained in step S51 (step S52). This processing is similar to step S22 of the initial learning processing.

Next, in step S53, the processing branches and shifts to the following three steps, depending on the update situations.

First, consider the case where there exists a shared learning model 5 that has been able to generate high-quality motion in other robots. If the shared learning model 5 is updated by other robots and it is desired to improve the motion quality of the robot 2a, the management unit 51 selects the first learning model and the second learning model in step S53. Then the management unit 51 trains the first learning model 3a and the second learning model 4a using the teaching data generated in step S52 (step S54), and the processing returns to step S53.

In addition, if high-quality motion can be acquired in the process of operating the robot 2a, the management unit 51 selects the shared learning model in step S53. Then the management unit 51 trains the shared learning model 5 using the teaching data generated in step S52 (step S55), and the processing returns to step S53.

Here, the management unit 51 performs either the first training in step S54 in which the first learning model 3a and the second learning model 4a are trained or the second training in step S55 in which the shared learning model 5 is trained, or alternates between the first training and the second training.

If the first learning model 3a, the shared learning model 5, and the second learning model 4a are trained simultaneously, the optimal structure is learned for only the robot 2a. As a result, the structure in which common information is learned by the shared learning model 5 and robot-specific input-output information processing is separated and learned by the first learning model 3 and the second learning model 4 collapses.

Therefore, if, in the process of step S51, data of high-quality motions that have not been achieved by other robots are obtained and the first learning model 3a and the second learning model 4, as well as the shared learning model 5, are both to be trained, steps S54 and S55 must be performed alternately.

After the desired motion model can be acquired in the robot 2a and the above update processing is completed, the shared learning model 5 and/or the first learning model 3a and second learning model 4a are stored in the robot 2a as the motion model (step S56).

FIG. 12D illustrates a configuration of the robot 2a. At this time, sensing data from the external/internal measurement unit 80 is input to the first learning model 3a, and the actuator 81 is driven on the basis of the predicted motion information output via the shared learning model 5 and the second learning model 4a. This allows the robot 2a to execute high-quality motion with the additionally obtained motion data, in the configuration shown in FIG. 12D, using the newly-stored shared learning model 5 and/or motion models of the first learning model 3a and the second learning model 4a.

In the present invention, the above method makes it possible to share and transfer learning information and learning models among a plurality of types of robots, especially even among robots with different mechanisms, structures, characteristics, or the like. By sharing and transferring high-quality motion acquired by other robots to robots that have not yet learned that motion, the training load, such as obtaining teaching data and tuning parameters, can be reduced and high-quality motion can be easily acquired.

Specific examples of the advantageous effects of the present invention will be described below. As an example, a description will be given of the application of the present invention to two types of robots: a smart robot that has a high degree of freedom of motion and is equipped with a wide range of sensor performance and types; and a simple robot that has the minimum configuration necessary to perform desired motion. Simple robots are lightweight, can be easily moved by remote devices (even if they fail, they will not damage objects), and can be easily trained with a small amount of motion data. However, advanced motion cannot be acquired. Smart robots are heavy, their systems are complex and delicate and cannot be easily moved, and they require a lot of motion data, which requires a large training load. However, smart robots have advanced sensing and motion capabilities, thereby allowing the smart robots to perform advanced and high-quality work that requires a knack for the art. Once both robots have initially trained with simple motion, the following advantages can be gained during the learning phase of a new specific desired motion.

First, the simple robot obtains motion data in step S31 of the unlearned motion learning processing, and in step S33, the motion is shared with the smart robot. Next, using the parameters of the shared learning model 5 acquired by the simple robot as initial values, the shared learning model 5 is tuned using the smart robot in step S55 of the individual learning processing. In this manner, the training load can be reduced and the acquisition of high-quality motion is facilitated compared to the case where the smart robot acquires and learns a large amount of motion data from the initial state, since the basic motion have been acquired by the simple robot. In addition, if the high-quality motion acquired by the smart robot here is shared with the simple robot in step S34, it is easier to acquire higher-quality motion than that obtained by the simple robot alone.

The configuration and advantageous effects of the present invention will be described below.

A robot motion learning device (1) including:
a plurality of first learning models (3a to 3c) that receive motion information at a certain time and convert the motion information into motion features, and also receive external information at the time and convert the external information into external features, for a plurality of types of robots (2a to 2c);
a shared learning model (5) that converts the motion features and external features output by the first learning models (3a to 3c) into predicted motion features at a next time that are common to the plurality of types of robots (2a to 2c);
a plurality of second learning models (4a to 4c) that convert the predicted motion features at the next time into predicted motion information, for the plurality of types of robots (2a to 2c); and
a management unit (51) that uses teaching data related to motion of each of the robots (2a to 2c) to train either the first learning model (3a to 3c) and the second learning model (4a to 4c) related to the robot (2a to 2c) or the shared learning model (5).

Thus, it is possible to reduce the training load on a learning model for controlling a plurality of types of robots.

The robot motion learning device (1) according to claim 1, in which the management unit (51) uses teaching data related to motion unlearned by each of the robots, to train the shared learning model (5) while keeping parameters of the first learning model (3a to 3c) and the second learning model (4a to 4c) fixed.

Thus, the training load on a new motion can be reduced.

The robot motion learning device (1) according to claim 1, in which the management unit (51) newly adds the first learning model (3a to 3c) and the second learning model (4a to 4c) corresponding to a robot to be newly added as an object to be controlled.

Thus, the training load on each motion of a new robot can be reduced.

The robot motion learning device (1) according to claim 1, in which the management unit (51) uses teaching data for the robot to be added, related to motion already learned by the shared learning model (5), to train the first learning model (3a to 3c) and the second learning model (4a to 4c) while keeping parameters of the shared learning model (5) fixed.

Thus, the training load on the newly added robot can be reduced.

The robot motion learning device (1) according to claim 1, in which, upon newly obtaining teaching data for a robot, related to a shared motion already learned by the shared learning model (5),
the management unit (51) uses the teaching data to perform either first training in which to only the first learning model (3a to 3c) and the second learning model (4a to 4c) corresponding to the robot are trained or second training in which only the shared learning model (5) corresponding to the shared motion is trained, or alternate between the first training and the second training.

Thus, the accuracy of the shared motion learned by the shared learning model (5) can be improved.

The robot motion learning device (1) according to claim 5, in which the shared learning model (5a, 5b) is provided for each of a plurality of shared motions, and
the robot motion learning device further comprises a motion designation unit (52) that selects and executes one of the shared learning models (5a, 5b) provided for each of the plurality of shared motions.

Thus, the accuracy of each of the shared motions can be improved.

The robot motion learning device (1) according to claim 1, in which the shared learning model (5) converts the external features output by the first learning models (3a to 3c) into predicted external features at the next time that are common to the plurality of robots (2a to 2c).

Thus, it is possible to easily determine that learning by the learning model has converged.

A robot motion learning system (60) including: the robot motion learning device (1) according to claim 1; and a plurality of types of robots (2a to 2c).

Thus, it is possible to provide a system that reduces the training load on learning models that controls a plurality of types of robots.

A robot motion learning method for learning motions of a plurality of types of robots (2a to 2c), including the steps of: causing a first learning model (3a to 3c) corresponding to a robot to learn processing for converting motion information and external information of the robot at a certain time into common motion features using teaching data related to the motion of the robot;
causing a shared learning model (5) to learn a time-series relationship of the common motion features related to motions common to the plurality of types of robots (2a to 2c) using the teaching data related to the motions of the plurality of types of robots (2a to 2c); and
causing a second learning model (4a to 4c) corresponding to the robot to learn processing for converting predicted values at a next time of the common motion features output by the shared learning model into predicted motion information of the robot at the next time using the teaching data related to the motion of the robot.

Thus, it is possible to reduce the training load on a learning model for controlling a plurality of types of robots.

### Modifications

The present invention is not limited to the above-described embodiment, and includes various modifications. For example, the above embodiment has been described in detail for easy understanding of the present invention, and is not necessarily limited to those with all the described configurations. A part of the configuration of one embodiment can be replaced with the configuration of another embodiment, and the configuration of another embodiment can be added to the configuration of one embodiment. In addition, it is possible to add, delete, and replace a part of the configuration of each embodiment with other configurations.

A part or all of the aforementioned configurations, functions, processing units, and processing means may be realized by hardware, such as integrated circuits, for example. Each of the above configurations, functions, and the like, may be realized in software by a processor interpreting and executing a program that realizes each function. Information such as programs, tables, and files that realize each function can be stored in a recording device such as a memory, a hard disk, or a solid state drive (SSD), or a recording medium such as a flash memory card or a digital versatile disk (DVD).

In each embodiment, control lines and information lines are those considered necessary for illustrative purposes, and not necessarily all control lines and information lines are shown in the product. In fact, almost all configurations may be considered interconnected.

### LIST OF REFERENCE SIGNS

1: motion learning device
2a to 2d: robot
3a to 3d: first learning model
4a to 4d: second learning model
5: shared learning model
51: management unit
52: motion designation unit
61: network
64: robot motion teaching device
70: calculation processing unit
71: CPU
72: ROM
73: RAM
74: external memory
78: system bus
77: communication interface
75: display unit
76: input unit
80: external/internal measurement unit
81: actuator
91a, 91b, 91c: external feature
92a, 92b, 92c: internal feature
99: recursive loop
93: external feature
94: internal feature
95: predicted external feature
96: predicted internal feature

What is claimed is:

1. A robot motion learning device comprising:
a plurality of first learning models that receive motion information at a certain time and convert the motion information into motion features, and also receive external information at the time and convert the external information into external features, for a plurality of types of robots;
a shared learning model that converts the motion features and external features output by the first learning models into predicted motion features at a next time that are common to the plurality of types of robots;
a plurality of second learning models that convert the predicted motion features at the next time into predicted motion information, for the plurality of types of robots; and
a management unit that uses teaching data related to motion of each of the robots to train either the first learning model and the second learning model related to the robot or the shared learning model.

2. The robot motion learning device according to claim 1, wherein
the management unit uses teaching data related to motion unlearned by each of the robots, to train the shared learning model while keeping parameters of the first learning model and the second learning model fixed.

3. The robot motion learning device according to claim 1, wherein
the management unit newly adds the first learning model and the second learning model corresponding to a robot to be newly added as an object to be controlled.

4. The robot motion learning device according to claim 1, wherein
the management unit uses teaching data for the robot to be added, related to motion already learned by the shared learning model, to train the first learning model and the second learning model while keeping parameters of the shared learning model fixed.

5. The robot motion learning device according to claim 1, wherein
upon newly obtaining teaching data for a robot, related to a shared motion already learned by the shared learning model,
the management unit uses the teaching data to perform either first training in which to only the first learning model and the second learning model corresponding to the robot are trained or second training in which only the shared learning model corresponding to the shared motion is trained, or alternate between the first training and the second training.

6. The robot motion learning device according to claim 5, wherein
the shared learning model is provided for each of a plurality of shared motions, and
the robot motion learning device further comprises a motion designation unit that selects and executes one of the shared learning models provided for each of the plurality of shared motions.

7. The robot motion learning device according to claim 1, wherein
the shared learning model converts the external features output by the first learning models into predicted external features at the next time that are common to the plurality of robots.

8. A robot motion learning system comprising:
the robot motion learning device according to claim 1; and
a plurality of types of robots.

9. A robot motion learning method for learning motions of a plurality of types of robots, comprising the steps of:
causing a first learning model corresponding to a robot to learn processing for converting motion information and external information of the robot at a certain time into common motion features using teaching data related to the motion of the robot;
causing a shared learning model to learn a time-series relationship of the common motion features related to motions common to the plurality of types of robots using the teaching data related to the motions of the plurality of types of robots; and
causing a second learning model corresponding to the robot to learn processing for converting predicted values at a next time of the common motion features output by the shared learning model into predicted motion information of the robot at the next time using the teaching data related to the motion of the robot.
